(19) United States
(12) Patent Application Publication
(10) Pub. No.: US 2026/0098605 A1
(43) Pub. Date: Apr. 9, 2026

(54) Extension Coupler

(71) Applicant: WorkWing LLC, Gunnison, CO (US)

(72) Inventor: Logan James Cattles, Gunnison, CO (US)

(21) Appl. No.: 19/189,381

(22) Filed: Apr. 25, 2025

Related U.S. Application Data
(60) Provisional application No. 63/639,465, filed on Apr. 26, 2024.

(51) Int. Cl. F16M 13/02; F16B 7/22

(52) U.S. Cl. CPC F16M 13/022; F16B 7/22

(57) ABSTRACT

A system and method for an extension is disclosed. The extension attaches to a structure, such as a trailer. The extension has two sides. There is a planar surface connecting the two sides. The planar surface can be located atop, the sides, to the bottom of the sides, or along the length of the sides. Each of the sides has an upstream end and a downstream end. Each side has a vertical slot creating mounts located in the upstream end of each side. The mounts are for coupling to a structure, such as via pocket stakes.

### BACKGROUND OF THE INVENTION

### Priority

The present invention claims priority to Provisional Patent No. 63/639,465 filed Apr. 26, 2024, the entirety of which is hereby incorporated by reference.

### TECHNICAL FIELD

The present invention relates to a system and method for an extension.

### DESCRIPTION OF RELATED ART

Workspace at a job site is often difficult to obtain. Not every job site has a table or sawhorse upon which plans or workpieces can be laid. Consequently, there is a need to provide additional workspace.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of an extension in one embodiment;

FIG. 2 is a top perspective view of a trailer with a pocket in one embodiment;

FIG. 3 is a perspective view of an extension coupled to a trailer in one embodiment;

FIG. 4 is a side view of an extension in one embodiment;

FIG. 5 is a top view of an extension in one embodiment;

FIG. 6 is a perspective view of an elongated planar bottom in one embodiment;

FIG. 7 is a perspective view of an adapter in one embodiment;

FIG. 8 is a perspective view of an adapter with an accessory in one embodiment;

FIG. 9 is a perspective view of a tray in one embodiment;

FIG. 10 is a perspective view of a tray coupled to an extension in one embodiment;

FIG. 11 is a perspective view of structure mount in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

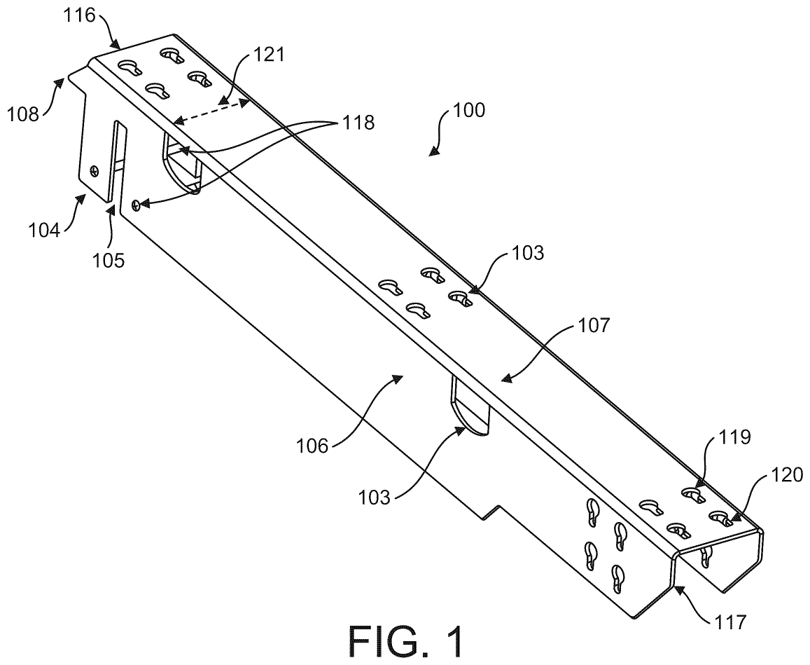

FIG. 1 is a perspective view of an extension 100 in one embodiment. The extension 100 can comprise virtually any structurally strong material. This includes metal such as steel or aluminum, as well as other hard plastics.

The extension 100 is an arm which extends from a structure and which can be used as a work surface. One embodiment will be discussed herein wherein the structure is a trailer. This is for illustrative purposes only and should not be deemed limiting. The structure can comprise a truck, a trailer, a wall, a post, etc. In one embodiment, as described below, the trailer or truck utilizes stake pockets 102.

Trailers and flatbed trucks are common in many jobsites. Trailers are used to haul and transport machinery, equipment, tools, etc. Thus, for many jobsites, trailers are a constant. Having the ability to couple to a trailer and offer additional work surfaces from the trailer is a significant benefit.

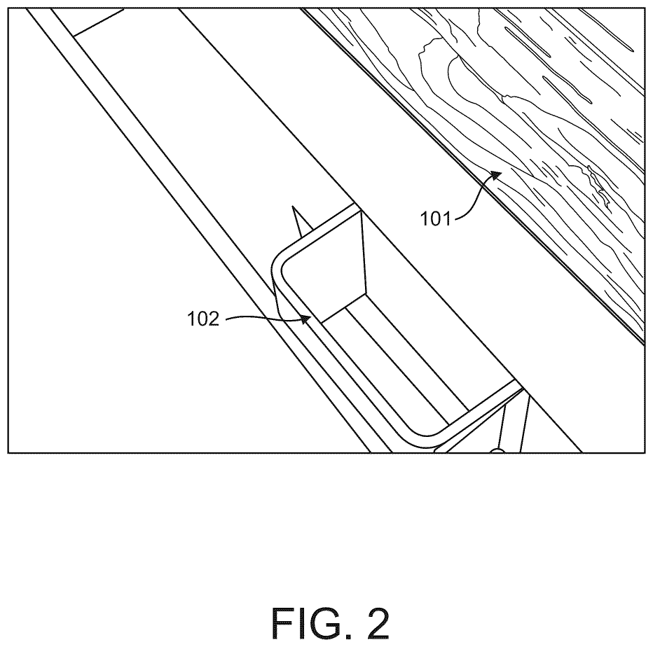

Trailers often have various pockets located at various locations on the trailers. In some embodiments the pockets are located around the outer periphery of the trailer. Turning to FIG. 2, FIG. 2 is a top perspective view of a trailer 101 with a pocket 102 in one embodiment. The pocket 102 can have virtually any shape. As depicted, the pocket 102 has a generally rectangular cross-section. One embodiment will be described wherein the extension 100 couples to a pocket 102 with a rectangular cross-section. This is for illustrative purposes only and should not be deemed limiting. In other embodiments the extension 100 can couple to pockets of circular, oval, square, etc. cross-sections.

Currently, the trailer will be loaded to machinery or materials, as previously described. However, by allowing an extension 100 to couple with a pocket 102 or similar receiver, an additional workspace can be provided. The extension 100 can utilize the structure and weight of the trailer, or other structure, to extend and offer a viable work surface not otherwise available.

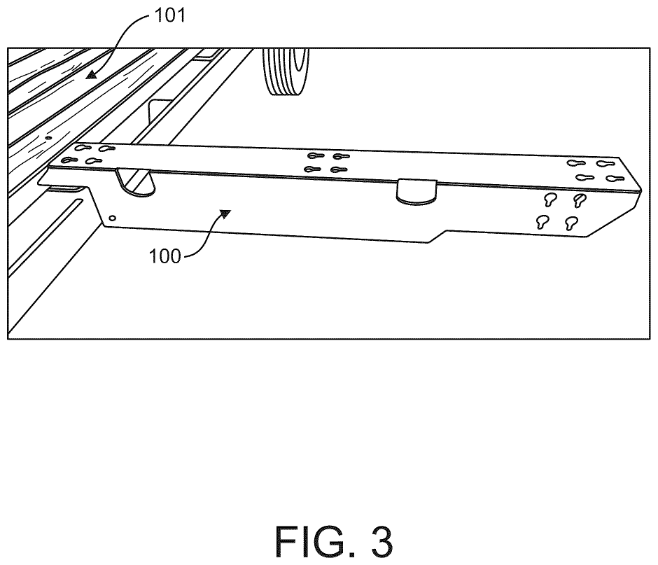

FIG. 3 is a perspective view of an extension 100 coupled to a trailer 101 in one embodiment. In this embodiment, a portion of the extension 100 is received by the pocket 102 of the trailer. The extension 100 then extends away from the pocket 102. As will be discussed, the extension 100 offers a workspace which can be utilized in a variety of ways.

As shown, the trailer has a length. The length of the trailer is parallel with the direction of travel. In the embodiment depicted, the extension 100 extends out in a direction perpendicular to the length of the trailer.

Consider workers of a steel company. Such workers transport heavy workpieces, such as steel objects using a truck or trailer. While unloading, it is common to lay these workpieces on the ground where they gather dirt, debris, and are exposed to moisture and other undesirable items which can damage the workpiece. Further, laying and organizing the large and heavy workpieces on the ground is undesirable and not ergonomic. However, utilizing an extension 100, the user is provided a platform upon which the workpiece can be stored, organized, etc., all from an elevated, and more ergonomic, platform. This reduces back injury, strain, etc. of the worker.

Turning back to FIG. 1, the extension 100 depicted comprises an upstream end and a downstream end. As used herein, upstream and downstream refer to relative locations along the extension. The portion closest to the trailer, or other structure, is the upstream end 116, whereas the end furthest from the trailer is the downstream end 117. As depicted, the downstream end 117 is on the lower right and the upstream end 116 is on the upper left.

The extension has two parallel side walls 106. The side walls 106 are vertically oriented and run the length of the extension 100. The length 100 is the maximum dimension and extends from the pocket 102 outward. In one embodiment the side walls 106 are generally planar.

Connecting the side walls 106 is at least one planar wall. The planar wall is approximately perpendicular to the side walls 106. As depicted in FIG. 1, the planar wall is a top wall 107. Thus, the top wall 107 connects to the top of the side walls 106. In other embodiments, however, the planar wall can be a bottom wall 109. In such embodiments, the planar wall attaches to the bottom of the side walls 106. The planar wall can extend from any location of the side walls 106.

The planar wall, the top wall 107 in FIG. 1, offers a planar surface which functions as a work surface. The planar wall can be used for a variety of purposes. If two or more extensions 100 are placed apart to one another, workpieces can be placed upon them. As but one example, if two extensions 100 are placed apart, then lumber pieces such as two-by-fours, can be placed upon the work extensions 100. This provides a straight, elevated, and often level surface upon which the work piece can be placed. The two-by-fours can be measured, cut, assembled, etc. Often metallic pieces need to be assembled. Rather than having to place the pieces on the uneven ground, the pieces can be placed upon the extensions 100. Aside from being located on a straight and level surface, the work surface is also elevated relative to the ground. This allows the workpiece to be adjusted as necessary at a comfortable and ergonomic height compared to leaning and hunching on the ground.

Additionally, some workpieces need to be adjusted or worked on with space below the workpiece, making working on the ground impossible. Consider the two-by-four which needs to be cut. A saw, for example, needs to extend downward below the two-by-four. If the two-by-four is carried by one or more extensions 100, since the lumber is elevated relative to the ground, the saw will not hit the ground when in use.

The extensions 100 also provide a planar surface upon which to spread plans, paper, etc. Building or construction plans must often be spread out to allow the builders to see multiple parts of the plans. Spreading such plans out on the ground or other surface is undesirable for a variety of reasons. The extensions 100, in some embodiments, provide a planar surface upon which paper and other plans can be spread and viewed from a desirable height.

As shown in FIG. 1, the top wall 107 extends only between the side walls 106. This is for illustrative purposes and should not be deemed limiting. In other embodiments, the top wall 107 will extend beyond the side walls 106. Thus, the width of the top wall 107, or other planar wall, which is measured in the dimension perpendicular to the length, can be varied. As shown, the width of the top wall 107 is the separation distance between side walls 106.

As shown, the top wall 107 comprises a plurality of receivers 103. As shown, the top wall 107 comprises three separate groups of four receivers 103. As shown, the receivers 103 on the top wall each comprise a first diameter section 119 coupled to a second diameter section 120. The second diameter section 120 has a reduced effective diameter compared to the first diameter section 119. This allows the first diameter section 119 to receive a coupling portion. When the coupling portion is adjusted to the second diameter section 120, this allows the coupling portion to lock into the second diameter section 120—securing the coupling portion in place.

The receivers 103 provide an anchor point whereby additional items can be coupled, anchored, and/or secured. Various accessories, discussed herein in greater detail below, can be utilized and coupled to the receivers 103. Further, different straps, hooks, etc. can be used to couple to the receivers 103.

The side wall 106 shows a receiver 103 having a dissimilar shape than the receivers 103 on the top wall 107. The receiver 103 on the side wall 106, as depicted, comprises a comparatively wider void which is sized to receive hooks, such as commonly used in a ratchet strap system. Thus, while the planar wall can be used for holding a workpiece, work plans, etc., the receivers 103 allow objects to be held and secured.

As noted, consider the two-by-four pieces which are stored on either a single extension 100 or along two or more extensions 100. The receivers 103, either on the planar wall, or the side walls 106, can be used to secure and couple the two-by-four pieces to the extensions. The ratchet straps, chains, etc. can couple the lumber, piping, etc. to the extensions 100. The workpieces, such as lumber, piping, material, equipment, etc. can be coupled when the trailer, for instance is stationary. In other embodiments, the workpieces are couple to the extensions 100 when the trailer is in transport. Thus, for example, the extensions 100 can be secured to the trailer, and then secured to the workpieces. The trailer can then be transported to a job site as desired.

FIG. 1 shows an extension 100 which has no moving parts and which is fixed. A fixed extension 100 refers to a single, non-moveable and rigid extension. In other embodiments, however, the extension 100 comprises two coupled pieces which can pivot about a hinge. FIG. 1 shows a hinge point 121 illustrated as a dashed line. This shows one potential location of a hinge. In such an embodiment, the portion of the extension 100 upstream of the hinge point 121 will remain horizontal and in the same plane as the pocket 102 of the trailer. The portion of the extension 100 downstream of the hinge point 121 will be able to pivot and rotate at the hinge point 121. Such embodiments can be beneficial during transport, for example. The extension 100 can be coupled with a workpiece as previously described. However, for transport purposes, the portion downstream of the hinge point 121 rotates to a more vertical position. This reduces the width of the trailer and the extensions when the trailer is moving down the road. In certain situations, the width of the trailer with the extension 100 will be too wide to transport on the road. However, when the extension 100 is pivoted to be partially in the vertical position, the width of the trailer with the extension 100 is sufficiently narrow enough to transport on the road. The user will not need to load and unload the workpieces from the extensions 100 prior to transporting. Rather, the extension 100 can simply be pivoted to a vertical position with the workpieces still coupled to the extension 100.

Consider elongated sections of pipe which are coupled to one or more extensions 100. When the extensions 100 are in the display position the portions upstream and downstream of the hinge point 121 are in the same plane. The user can load and unload the pipes. Any remaining sections of pipe remaining coupled to the extensions 100 can remain on the extensions 100 when the extensions 100 are transitioned to their transport position. In such a position, the portion downstream of the hinge point 121 is angled upward to reduce the total length of the extension 100. The pipe can remain coupled to the extension 100 during transport to a new jobsite. Other workpieces such as ladders, equipment, etc. can be coupled to the extension 100.

In some embodiments the extensions 100 comprise a lock mechanism to lock and maintain the extensions in either the display or transport position. In still other embodiments, hydraulics, motors, etc. can be utilized to transition the extensions 100 from a display to a transport position.

As noted, in some embodiments, the extensions 100 can comprise one or more hinge points 121. In other embodiments, and as depicted, the extensions 100 comprise a fixed extension. Fixed extensions, in some embodiments, are less expensive to manufacture. Further, in some embodiments, the extensions offer increased load capacity.

As noted, the upstream end 116 couples to a structure, such as a trailer. As shown, the extension 100 comprises a mount 104. In one embodiment, as illustrated, the mount 104 is received by a void in a structure. In the embodiment depicted in FIG. 3, the mount 104 is received by the pocket 102 of the trailer. The pocket 102 comprises a generally rectangular shape. The mount 104, in FIG. 1, also comprises a generally rectangular shape which fits within the pocket 102. The mount 104 is created by a slot 105 in each sidewall 106. The slot 105 has an upstream edge and a downstream edge. The upstream edge of the slot 105 fits within the pocket 102. The downstream edge of the slot 105 is adjacent to the outside of the pocket 102. Thus, the width of the slot 105 is sufficient to receive the perimeter of the wall of the pocket 102. If the wall of the pocket 102 is thicker, then the slot 105 likewise needs to be thicker to accommodate the wall.

As shown, the mount portion on the first side wall 106 is coupled to the mount portion of the second side wall 106 by a support 118. The support 118 can comprise a bolt, a rod, or other connecting piece. The support 118 increases the strength and rigidity of the extension 100. Without the support 118, the extension 100 would not be able to support as much weight. The support 118 can be coupled to each sidewall 106 via any method known in the art. The support 118 can be welded or soldered onto the sidewall 106. In other embodiments the support 118 can be bolted, screwed, etc. to couple to the sidewall 106.

As depicted, the extension 100 comprises two separate supports 118. One is located upstream of the slot 105 and an additional support 118 is located immediately downstream of the slot 105. The additional support 118 increases the structural rigidity and strength of the extension 100. In one embodiment the extension 100 comprises only two supports 118. As shown, the supports 118 are located adjacent to the slot 105. This provides the support at the location where the extension 100 attaches to the structure, such as the stake pockets 102.

In one embodiment the extension comprises a single blank which is cut and bent to create the extension 100. In one embodiment, the support 118 is a separate component which is affixed to the extension 100 after formation. Aside from the support 118, the extension 100 comprises a single integrally made piece.

The extension 100, in one embodiment, further comprises a lip 108. The lip 108 extends upstream of the mount 104. In one embodiment, the lip 108 is the most upstream portion of the extension 100. The lip 108, as depicted, is formed on each side wall 106. The lip 108 is on the upper-most portion of the side wall 106. As shown, the lip 108 comprises a triangular shape. The lip 108 contacts the support and provides support for the extension 100. Because the lip 108 extends and contacts the support, such as the trailer, the lip 108 ensures the fixed extension 100 cannot rise upwards due to the presence of the lip 108 contacting the trailer.

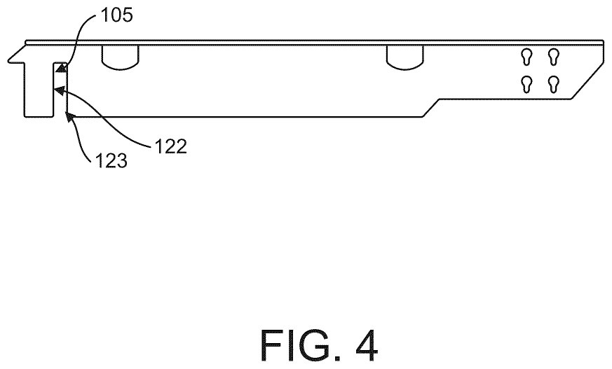

Turning now to FIG. 4, FIG. 4 is a side view of an extension in one embodiment.

FIG. 4 illustrates the slot 105, along with the upstream edge 122 and the downstream edge 123. As can be seen, the slot 105 does not extend for the entirety of the side wall 106. Instead, the slot 105 terminates along the height of the side wall 106.

In some embodiments, and as depicted, the upstream edge 122 and the downstream edge 123 are not parallel.

As depicted, the upstream edge 122 forms an angle of about 88.5 degrees relative to the horizontal portion of the lip 108. The horizontal portion of the lip 108, in one embodiment, is parallel with the planar wall, or the top wall 107 as shown. Thus, the upstream edge 122 does not form a right angle. If the upstream edge 122 sat at a right angle there would be give and slack when the mount 104 is received in the pocket 102. However, because the upstream edge 122, the edge which is received inside the pocket 102 has a slight angle which allows some slack when weight is applied to the extension. As noted, the upstream edge 122 does not form a right angle but the downstream edge 123 does form a right angle.

In one embodiment, the total length of the extension is about 32.96 inches. Discounting the lip 108, the top wall 107 is 32 inches in length. Certainly, this length can be increased or decreased depending upon the application.

The extension 100, in one embodiment, is about 4.23 inches in height. As with the length, this height can be adjusted depending upon the desired application.

As shown, the downstream end has a void section whereby the height decreases in a stair step as the length moves downstream. This allows for reduction of material costs. Further, as can be seen, this avoids sharp edges and corners which can grab or cut a user when walking by the extension 100. Thus, in one embodiment, the extension 100 comprises rounded edges.

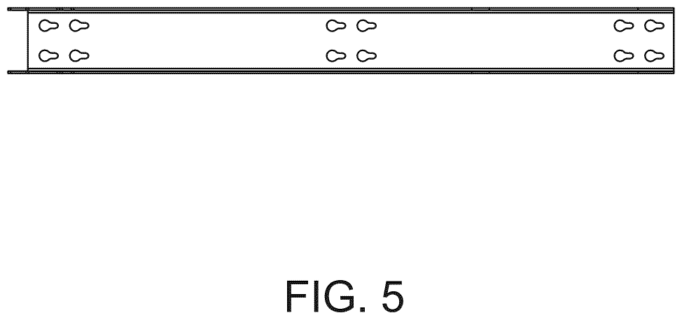

Turning to FIG. 5, FIG. 5 is a top view of an extension in one embodiment. FIG. 5 shows the three separate groups of receivers 103 previously described. The location of these groups can be varied depending on the desired application.

FIG. 5 shows that the top wall 107 has a width of about 3 and ¼ of an inch. This can be adjusted depending on the desired application. As noted, this can be increased to extend beyond the sidewalls if desired to provide additional planar surface.

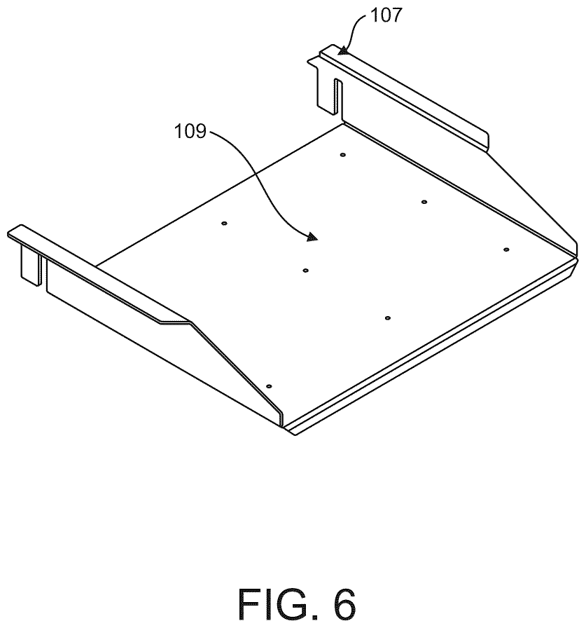

Turning now to FIG. 6, FIG. 6 is a perspective view of an elongated planar bottom wall 109 in one embodiment. While an embodiment has been described wherein the workpiece sits atop the extension, in other embodiments, the work pieces within or below the extension. As shown, the planar wall comprises a bottom wall 109. The bottom wall 109 extends from the bottom of the side walls 106.

As can be seen, the side walls 106 are separated by a greater distance than the extension 100 in FIG. 1. In this embodiment, the side walls 106 fit in separate pockets 102, whereas the extension in FIG. 1 both side walls 106 fit within the same pocket 102. Coupling with two separate pockets 102 allows for the utilization of a wider bottom wall 109.

The bottom wall 109 can be used in the same manner as the top wall 107 previously discussed. In fact, as depicted, the extension comprises two opposing top walls 107 extending outward from the side wall 106 in opposite directions. This is for illustrative purposes only and should not be deemed limiting. The top walls 107 can extend inwardly, outwardly, or combinations thereof. The top walls 107 provide a surface upon which a workpiece can be placed.

In one embodiment, the bottom wall 109 configuration allows for the utilization of a rotating saw to cut a work piece. Consider the two-by-four lumber discussed previously. The lumber can be placed across the extension 100 such that it is resting on the opposing top walls 107. The distance between the top wall 107 and the bottom wall 109 provides sufficient room to cut the workpiece with a rotary saw, for example, without hitting the bottom wall 109 with the saw. Such a configuration provides for a safe and effective location to cut or saw a work piece.

In alternate orientations, the bottom wall 109 does not exist and instead the top wall 107 extends between separated side walls 106. As can be appreciated, this provides a large planar workspace.

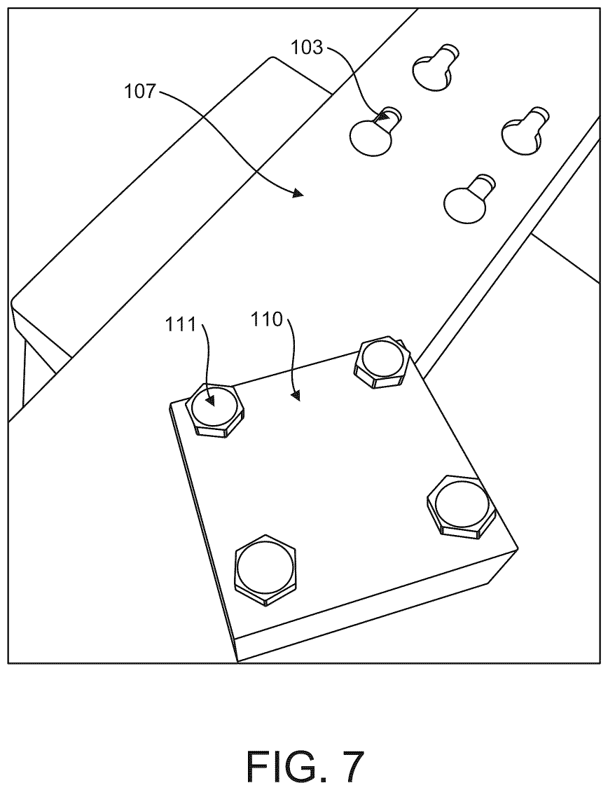

Turning to FIG. 7, FIG. 7 is a perspective view of an adapter 110 in one embodiment. The adapter 110 is any object that couples to the extension 100 via the receiver 103. As shown, the adapter 110 is a planar surface which has connectors 111 which couple with the receiver 103. As shown, the connectors 111 each comprise a bolt. The head of the bolt has a larger diameter than the body of the bolt. As such, the head of the bolt can be inserted through the first diameter portion 119 of the receiver 103. The first diameter portion 119 is sized to receive the bolt head of the connector 111. Thereafter, the bolt can be pressed to the second diameter portion 120. The second diameter portion 120 can receive the body of the bolt, but it is too small to allow the bolt head to pass. In this manner, the second diameter portion 120 locks the connector 111 in place.

As can be seen, the adapter 110 comprises four separate connectors 111, each connector 111 spaced to align with a corresponding receiver 103. Because there are four spaced-apart receivers 103 in a square pattern, the adapter 110 likewise has four spaced-apart connectors 111 which are likewise in a square pattern. Accordingly, the pattern of the connectors 111 mimics the pattern of the receivers 103.

While four connectors 111 are shown, a single connector 111 can also be used to couple to a single receiver.

One benefit of an adapter 110 which has existing connectors 111 is that the adapter 110 can be coupled to the extension 110 without any tools. The adapter 110 can be mated with the receivers 103 by simply aligning and locking in place. No additional tools are required. This allows the adapter 110 to be quickly and easily coupled and decoupled from the extension 100.

The bottom of the adapter 110 is shown in FIG. 7. The top of the adapter 110 can have virtually any type of accessory which can be added to the extension 100. This can include clamps, hooks, etc. The accessory can comprise a half-pipe circular shape to house and secure round objects, like a pipe. The accessory can comprise a tool, equipment, mount, etc. Virtually anything that can utilize a mount can be mounted. As but one example, a camera or tri-pod can be mounted via an adapter 110. Crews may utilize laser levelers, survey equipment, and other tools. Thus, there are many different accessories, mounts, etc. which can be added and coupled to the receiver 103.

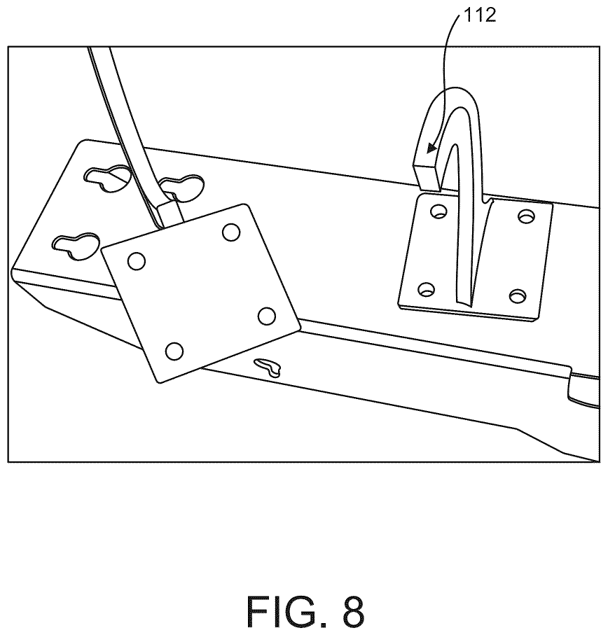

FIG. 8 is a perspective view of an adapter 110 with an accessory 112 in one embodiment. In this embodiment, contrasted with the adapter 110 of FIG. 7, the adapter of FIG. 8 does not have built-in connectors 111. Rather, connectors 111 must be separately added to couple the adapter 110 to the receivers. As noted, the connectors 111 can comprise nuts, bolts, screws, nails, and the like. As but one example, after the adapter 110 is aligned with the receivers 103, a bolt can be inserted through the aligned holes of both the adapter 110 and the receiver 103 and then capped with a nut and tightened as desired.

FIG. 8 depicts wherein the accessory 112 comprises a C-shaped mount. Such a mount provides a rounded surface which is ideal for carrying rounded workpieces, such as pipes. This accessory 112 provides for efficient and safe storage, display, and transport of round workpieces, equipment, or materials.

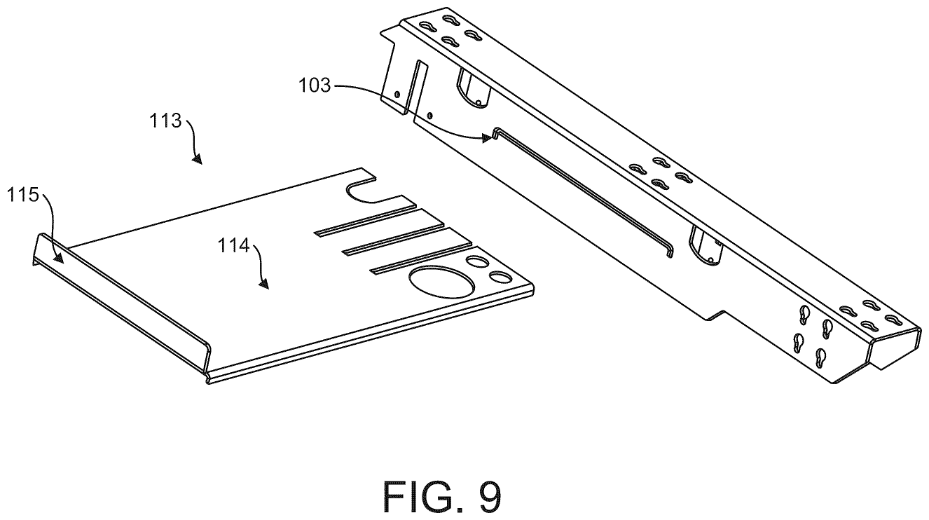

As noted, the receivers 103 can be used to couple additional objects to the extension 100. FIG. 9 is a perspective view of a tray 113 in one embodiment. The tray 113 is one type of object which can be coupled to the extension 100. As depicted, the extension 100 comprises a U-shaped receiver 103. Specifically, the receiver has a void through the side wall 106 which comprises an elongated horizontal line which extends along the length of the extension 100. Vertical voids extend along from each end of the horizontal line making a U-shaped receiver 103.

The tray 113 comprises a width which corresponds to the elongated horizontal line. The tray has extensions at either side which correspond with the vertical voids of the U-shaped receiver 103. As can be seen, the tray 113 has a cross-section which is similar to the cross-section of the U-shaped receiver 103. Other shaped receivers 103 can also be utilized provided the tray cross-section is shaped so as to be received by the receiver 103.

The tray 113 has a planar section 114 and a stop 115. The stop 115, as depicted and in one embodiment, is perpendicular to the planar section 114. As can be appreciated, the tray 113 can be inserted until the stop 115 reaches the side wall 106. The stop 115 prevents further entry by the tray 113 and provides support for weight applied on the tray by directing the force against the side wall 106. The stop 115 is shown as extending upward from the planar section 114, but the stop 115 can also extend downward.

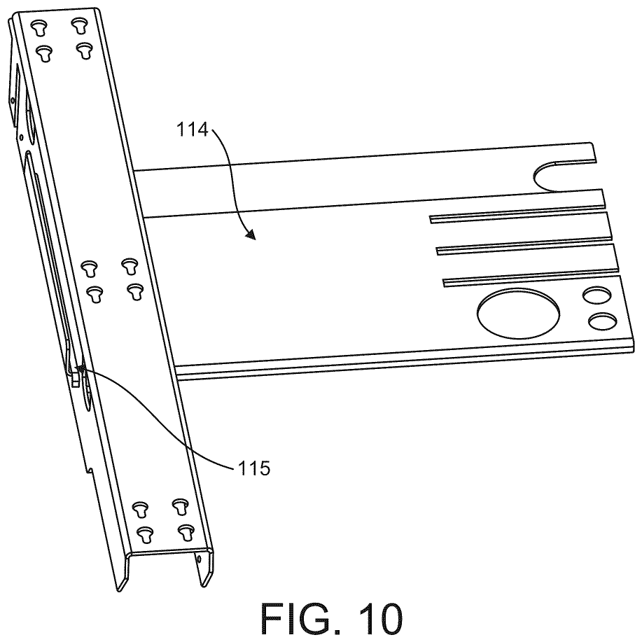

FIG. 10 is a perspective view of a tray 113 coupled to an extension 100 in one embodiment. As shown, the stop 115 is on the left side of the extension 100. The stop 115 rests adjacent to the side wall 106.

As can be appreciated, in the embodiment depicted in FIG. 10, both side walls 106 comprise aligned receivers 103 which have the same cross-section. Thus, the tray 113 is inserted through the receivers 103 on both sidewalls.

The tray 113 provides even additional workspace. The planar portion 114 can be used to hold tools, papers, plans, workpieces, equipment, etc. As shown, the planar portion 114 can comprise voids which can serve a variety of purposes. As shown, the voids can be used as cupholders, tool holders, etc. The tray 113 demonstrates how additional workspace can be added to the extension 100.

The extension 100 is very sturdy. As noted, the extension 100 can comprise a variety of materials and thicknesses. In one embodiment the extension 100 comprises steel and a thickness of about ⅛ of an inch. However, the thickness can be increased or decreased as desired to increase strength, decrease cost, etc. The extension 100 with ⅛ inch steel, in one embodiment, can support upwards of 900 pounds. In many embodiments, the support structure, such as the trailer, will fail before the extension 100 fails.

While an embodiment has been described whereby the extension 100 is attached to a structure, such as a trailer, this is for illustrative purposes only and should not be deemed limiting. When a user has obtained an extension 100, the extension 100 can be coupled as described herein to virtually any structure. If the extension 100 is designed to couple with pockets 102, then a structure mount can be utilized to couple the extension 100 to a support.

Consider, for example, a planar wall. Perhaps the job site has a wall constructed but is lacking in workspace. A structure mount can be coupled to the wall at the desired height. Thereafter, the extension 100 can couple to the structure mount as previously described.

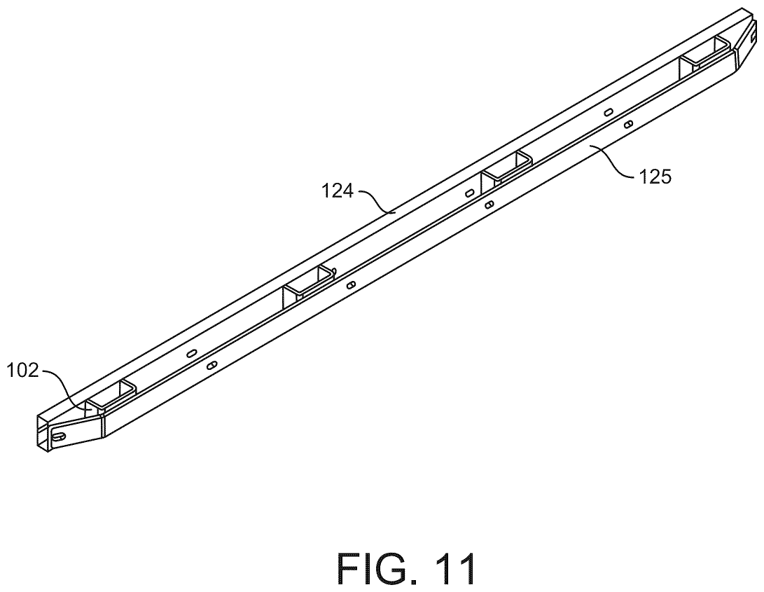

FIG. 11 is a perspective view of structure mount in one embodiment. As can be seen, the structure mount has a plurality of spaced-apart pockets 102. The pockets 102 are similar to the pockets 102 of the trailer discussed above. The structure mount has a backer tube 124. As shown, the backer tube 124 has a height of about 3 inches and a thickness of about 1 and a quarter inches. The backer tube 124 has voids through which a connector such as a nail, screw, bolt, etc., can couple the backer tube 124 to a structure.

The structure mount further comprises a front plate 125 which rests in front of the pockets 102.

The structure mount can be coupled to virtually any structure. This can include a wall, a horizontal rail or post, etc. The structure mount can be mounted inside a structure such as a house or barn, or outside a structure. The structure mount allows the extension 100 to be utilized in locations other than a trailer.

The extension system described herein has a plurality of advantages which were not previously attainable. First, the extension provides a flat and level workspace. As noted, on a jobsite, particularly jobsites which are outside, flat and level workspaces are not always available. Sawhorses, for example, are not always available. However, a trailer or other structure is often present at a jobsite. The extension provides a readily deployable surface which can be flat and level.

Second, as noted, the extension 100 provides an ergonomic height at which to work on a workpiece. Often the user had to work on a workpiece located on the ground. Elevating the workpiece to a more comfortable height is more ergonomically beneficial to the user.

Third, the extension 100 can be easily coupled and decoupled from a structure. In the pocket example noted, the extension 100 can be coupled and decoupled without any tools. The extension 100 uses weight and leverage to secure the extension 100 in place. The ability to couple without tools increases the speed of deployment and retrieval. Further, the elimination of tools reduces the likelihood that a portion of the system will be lost. As such, the ability to couple and decouple to a structure offers benefits.

Fourth, the extension 100 provides a strong workspace which can hold and secure heavy loads.

Fifth, the extension 100 offers the ability to display and transport goods, material, tools, etc.

Sixth, the extension 100 includes receivers which allow the user to couple other tools, adapters, etc.

While the invention has been particularly shown and described with reference to a preferred embodiment, it will be understood by those skilled in the art that various changes in form and detail may be made therein without departing from the spirit and scope of the invention.

What is claimed is:

1. A system for an extension, said system comprising:
two sides;
a planar surface connecting said two sides;
wherein said two sides each contain an upstream end and a downstream end;
wherein each of said sides comprises a vertical slot creating mounts located on the upstream end of each side.

2. The system of claim 1 further comprising a plurality of receivers on said planar surface.

3. The system of claim 1 further comprising a plurality of receivers on said two sides.

4. The system of claim 1 wherein said vertical slot comprises an upstream edge and a downstream edge, and wherein said upstream edge has a reduced angle compared to said downstream edge.

5. The system of claim 1 wherein said mount is sized to fit within a trailer pocket.

6. The system of claim 1 wherein each mount is coupled via a perpendicular support.

7. The system of claim 1 wherein said planar surface is located on a top side of said extension.

8. The system of claim 1 wherein said planar surface is located on a bottom side of said extension.

9. The system of claim 2 further comprising an adapter for coupling with said receivers.

10. The system of claim 9 wherein said adapter comprises a plurality of connectors for coupling with said receivers.

11. The system of claim 9 wherein said adapter comprises an accessory.

12. The system of claim 1 further comprising a tray which couples with a receiver on one of said sides.

13. The system of claim 12 wherein said tray comprises a planar workspace and a stop, wherein said stop is perpendicular to said planar workspace.

14. The system of claim 1 comprises a support extending between said two sides located on said mount, and a support located downstream of said slot.

15. The system of claim 1 wherein said extension is fixed.

16. The system of claim 1 wherein said extension comprises a hinge point.

17. The system of claim 2 wherein said plurality of receivers each comprise a first diameter portion coupled to a second diameter portion, and wherein said receivers are set apart in a square pattern.

18. The system of claim 1 further comprising a stake pocket located on a trailer, wherein said stake pocket receives both of said mounts.

19. The system of claim 18 wherein said stake pockets receive said mounts without any additional tools.

20. The system of claim 18 wherein said trailer has a length, and wherein said extension extends perpendicular to the length of the trailer.
